(19) United States
(12) Patent Application Publication
(10) Pub. No.: US 2003/0178129 A1
(43) Pub. Date: Sep. 25, 2003

(54) Method of adapting a paint transfer image to the generation of a mural

(76) Inventor: Jerry Rosenfeld, Red Bank, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/308,231

(22) Filed: Dec. 2, 2002

Related U.S. Application Data
(60) Provisional application No. 60/337,907, filed on Dec. 3, 2001.
(60) Provisional application No. 60/409,646, filed on Sep. 10, 2002.

(51) Int. Cl. B44C 1/165

(52) U.S. Cl. 156/230

(57) ABSTRACT

A method for creating imagery on a surface by establishing a visual boundary between two surface color regions and applying a dry transfer object proximate the visual boundary such that when the dry transfer object is substantially the same color as one of the surface regions, a negative space effect is created within the second surface color region to define thereby a desired image.

### CROSS-REFERENCE TO RELATED APPLICATIONS

This application claims benefit of U.S. provisional patent application serial No. 60/337,907, filed Dec. 3, 2001 (Attorney Docket RSFD/002P) and No. 60/409,646, filed Sep. 10, 2002 (Attorney Docket RSFD/006P), which are herein incorporated by reference in their entireties.

### BACKGROUND OF THE INVENTION

1. Field of the Invention

The invention relates to methods for generating large-scale ornamentation such as a mural using optically integrated media.

2. Description of the Prior Art

Presently, murals and other ornamental imagery are generated using a skilled artisan whose function it is to paint upon a surface, such as the side of a building or an interior or exterior wall of a house, the image to be displayed.

### SUMMARY OF THE INVENTION

The invention comprises a system and method for adapting a paint transfer image to the generation of a mural or other imagery.

Specifically, one or more regions of a wall or other structure are painted using respective colors such that demarcation points between the various regions are denoted by changes in color. A predefined image including image sub-elements of each color bordering the demarcation point is then applied using, for example, a paint transfer process (e.g., a “dry” transfer process). In this manner, the visual impact of both the painted portion and transferred portion of the resulting imagery is enhanced by the complementary nature of the respective colors. It is also noted that complementary textures may be advantageously employed in place of, or in addition to, the complementary colors.

A method according to one embodiment of the invention comprises: establishing a visual boundary between at least two surface color regions; and applying a dry transfer object proximate the visual boundary; wherein the dry transfer object comprising imagery having shading regions adapted to the at least two surface color regions; the dry transfer object-shading regions defining a visual boundary in substantial alignment with the surface color region visual boundary.

### BRIEF DESCRIPTION OF THE DRAWING

The teachings of the present invention can be readily understood by considering the following detailed description in conjunction with the accompanying drawings, in which:

FIGS. 1-6 depict imagery useful in understanding useful in understanding the present invention.

To facilitate understanding, identical reference numerals have been used, where possible, to designate identical elements that are common to the figures.

### DETAILED DESCRIPTION OF THE INVENTION

The subject invention will be primarily described in the context of disposing coatings such as paint and objects such as dry transfer decals upon the surface of the wall. However, it will be appreciated for those skilled in the art that the present invention is readily adaptable to any two or three-dimensional surface. As such, the term surface as used herein should be broadly interpreted as comprising any surface upon which a coating and dry transfer decal may be disposed.

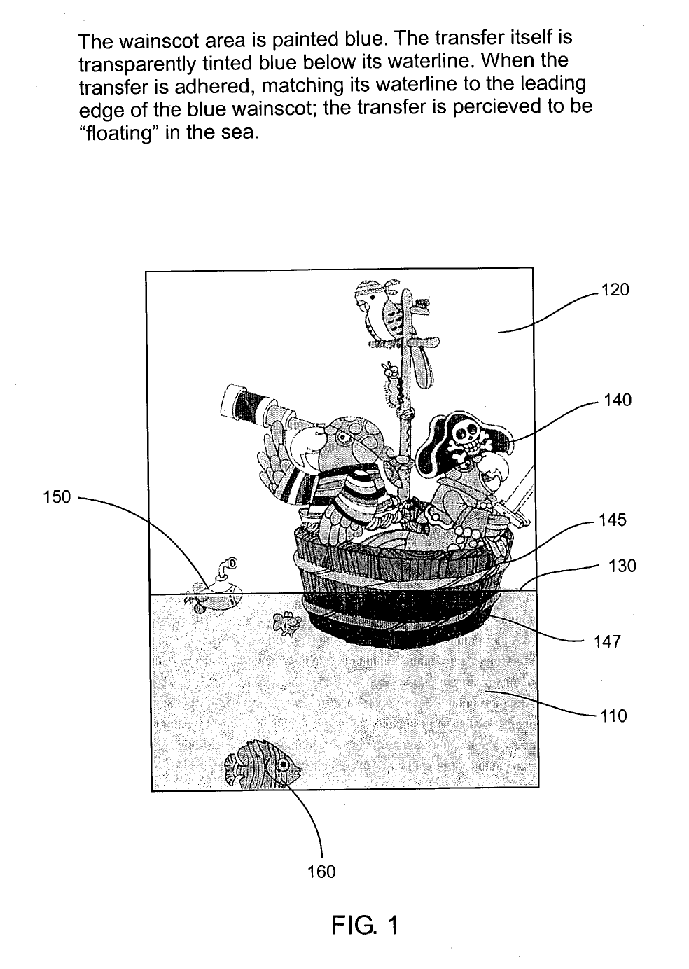

In FIG. 1, a first color region 110 and a second color region 120 meet at a demarcation line 130. The first color region 110 is a light blue shade reminiscent of water, while the second color region 120 is a pale shade reminiscent of sky. The demarcation line 130 visually indicates a water/sky interface line. A first object 140, illustratively some pirate-like creatures in a floating half-barrel is disposed upon the two color regions 110 and 120 along the demarcation line 130. That is, the object 140 includes a floating structure having shading reminiscent of (and complementary to) a barrel above water 145 and a barrel below water 147. A submarine shaped object 150 is also disposed upon the demarcation line 130 and includes shading appropriate to respective above water and submerged portions of a submarine. A fish shaped object 160 is fully located within the blue portion 110 and is shaded in a manner representative of a fish under water.

The FIG. 1 imagery achieves a believable visual effect by utilizing paint transfer or dry transfer objects having appropriate shading, coloring and/or textures with respect to a coating (e.g., paint) such that the object portions on the demarcation line 130 provide in a high quality and believable image.

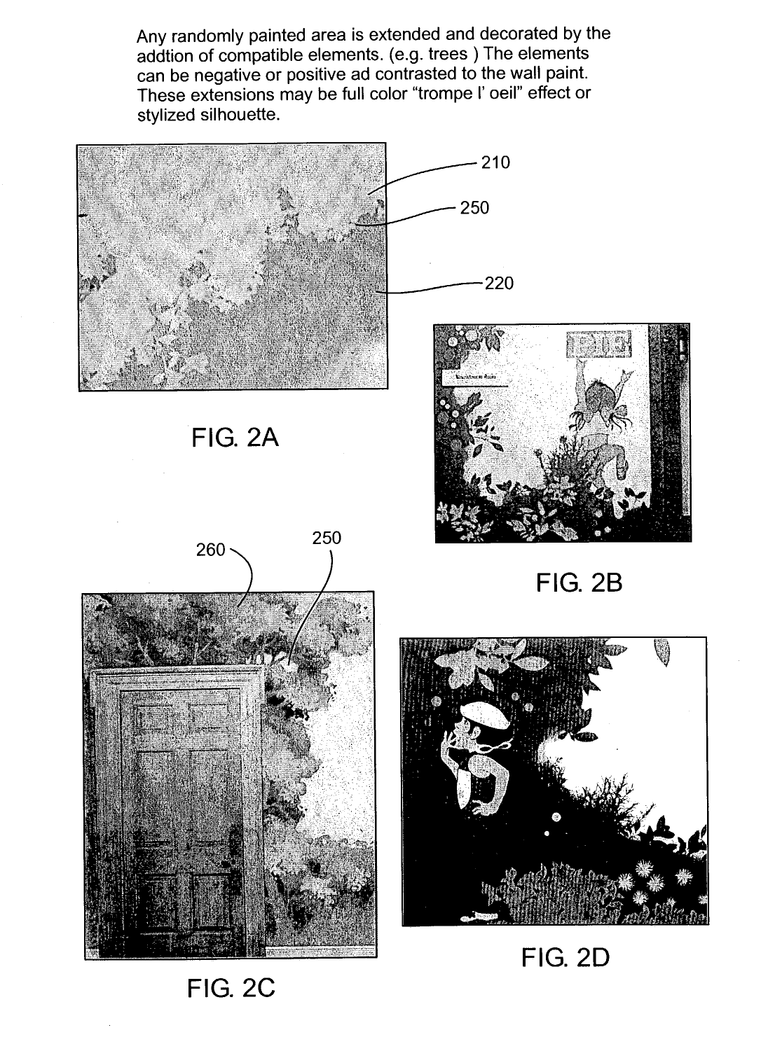

The imagery discussed above with respect to FIG. 1 and below with respect to FIGS. 2-6 is primarily formed using ordinary house paint applied to a wall. The dry transfer decals and/or paint overlays are preprinted and intended to be used with paint of the particular color and/or texture applied to the wall. Thus, the bulk of the material (i.e., the paint) applied to a surface to produce the desired imagery comprises a first medium (paint) which is less expensive to use than a second medium (dry transfer products).

FIG. 2 depicts various imagery formed in accordance with the present invention. For example, as shown in FIG. 2A, a wall painted white 210 has painted over it a green portion 220. A compatible element 230 is disposed about the green portion 220 to create an image of trees. It is noted that the compatible element 230 is color-compatible with the white portion 210 of the wall. It should be noted that the compatible element 230 can also be made compatible with the green portion 220 of the wall if desired. Similarly, and referring to FIGS. 2B, 2C and 2D, white portions of a wall are augmented by decorative transfers. It is noted that the decorative transfers are compatible with the white portions and convey the particular impression.

The white portions of the wall operate to provide a “negative space” that cooperates with the dry transfer decal portions intruding into the white portions. Specifically, referring to FIG. 2C, it is noted that a white portion 250 bounded by green portions reminiscent of trees 260 defines therein a negative space giving the illusion of sky or atmosphere. The use of negative space wherein the negative space is generated using the inexpensive first medium (i.e., paint) and the boundary elements are generally using a more expensive second medium (i.e., dry transfer medium).

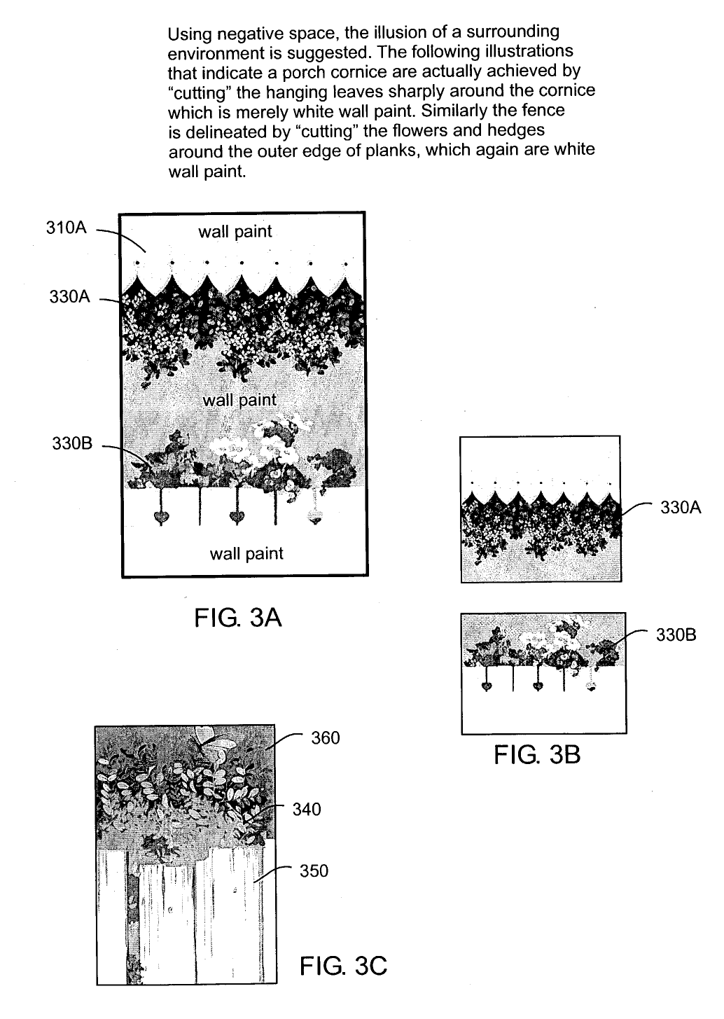

FIG. 3 depicts additional imagery formed according to the present invention. For example, FIG. 3A depicts a portion of a wall that is painted white in upper 310A and lower 310B regions, and painted blue 320 in a central region. The boundary between the upper 310A and blue 320 regions is modified by the application of a first paint transfer 330A, while the boundary between the lower 310B and blue 320 regions is modified by a second paint transfer 330B. The first 330A and second 330B paint transfers are individually shown in FIG. 3B. Of particular note is the optical functioning of the paint transfers to create imagery reminiscent of a fence with flowers emerging therefrom. Similarly, FIG. 3C depicts a wall having a white lower portion 350 and a blue upper portion 360 with a paint transfer 370 disposed therebetween to give an image of a fence in front of a row of hedges.

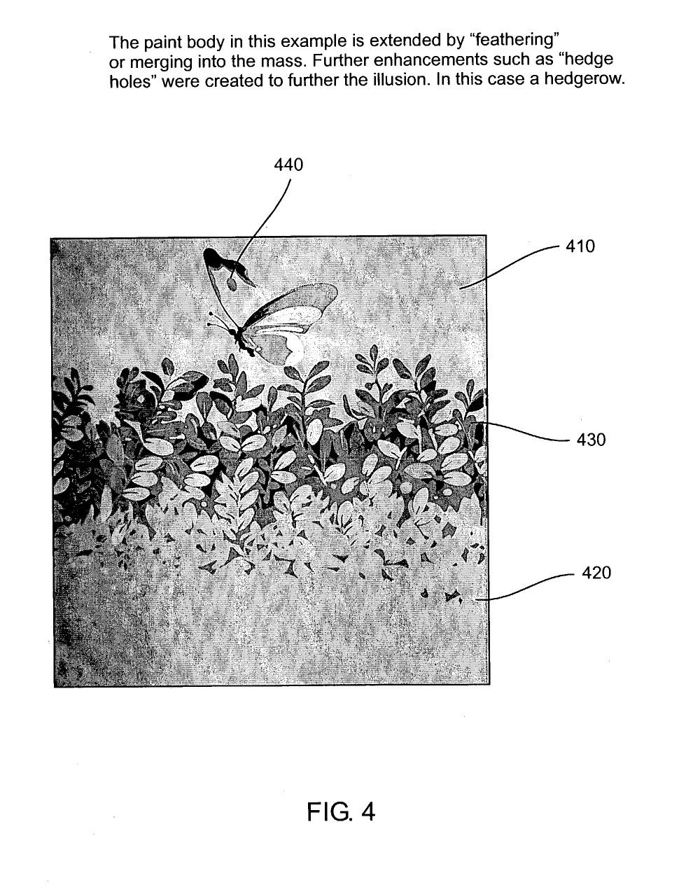

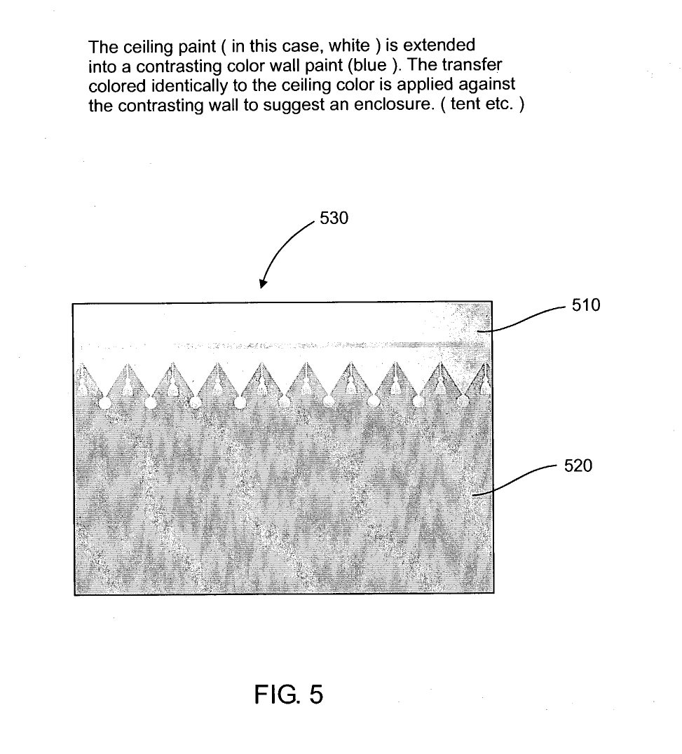

FIGS. 4 and 5 depict additional techniques adapted according to the present invention. Specifically, FIG. 4 depicts a first coating 410 reminiscent of sky or atmosphere, a second coating 420 reminiscent of deep color within the depicted hedge row, and a demarcation line obscured by a region of hedge row or leaf—reminiscent dry transfer imagery. It is further noted that the second or hedgerow-coated region 420 has included therein dry transfer imagery reminiscent of optical imperfections and other realistic hedgerow properties. A butterfly 440 is depicted as resting upon the dry transfer hedgerow top region 430. The butterfly 440 may be depicted using the same dry transfer or an additional dry transfer, such as placement of this decorative element may be controlled by the user.

FIG. 5 depicts a white region of, illustratively, a ceiling marching into a blue region of, illustratively, a wall and having disposed therebetween a dry transfer applique that gives a particular border effect. Specifically, the dry transfer applique conforms in color to the wall region color 520 to utilize the ceiling light color as a negative space which defines the border edge treatment 530.

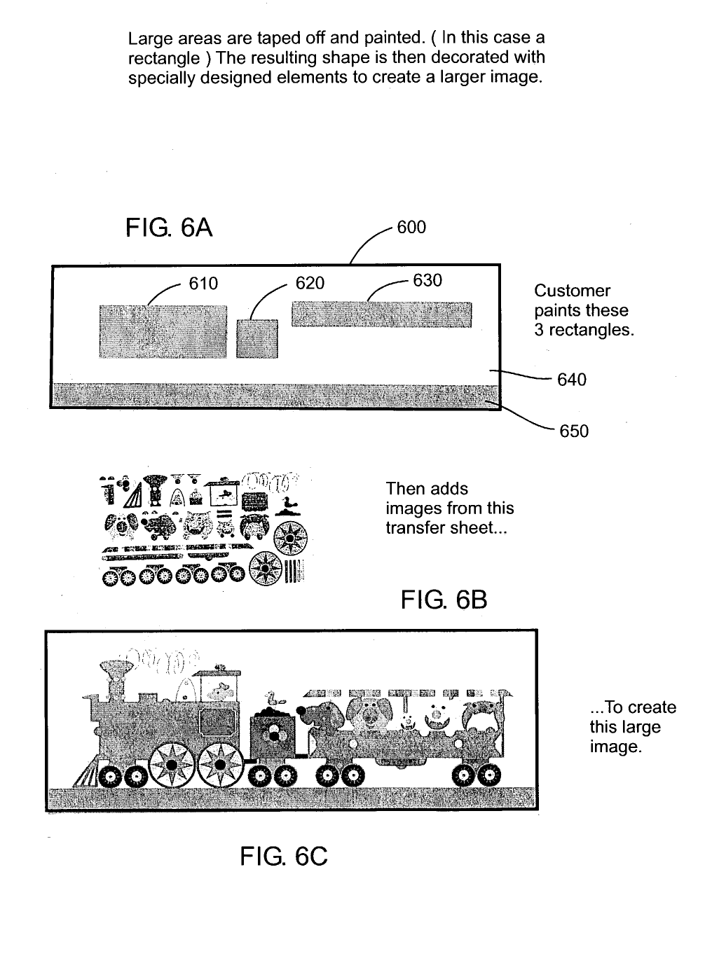

FIG. 6 depicts a process for generating imagery according to the present invention. Specifically, referring to FIG. 6A, a wall 600 is painted white 640 and includes an orange object 610, a pink object 620, and two blue objects 630 and 650. These objects will be augmented by paint transfers to become portions of the final image. FIG. 6B depicts various paint transfers on a transfer sheet that will be used to augment the wall of FIG. 6A. It is noted that the colors of the objects on the paint transfer sheet are complementary to the colors painted on the wall 600 of FIG. 6A. For example, the orange block 610, which will be used to represent a train engine, is the same color as various portions of the train engine to be provided by the paint transfer sheet objects.

FIG. 6C depicts the final image wherein the paint transfer objects of FIG. 6B have been affixed to various locations on the wall 600 of FIG. 6A. The process described herein results in the use of relatively small amounts of paint transfer imagery, such that associated costs are kept low. This is achieved by using matching paint colors to provide for large expanses of the imagery on the wall.

The subject invention advantageously provides the ability to rapidly create ornate and/or complicated imagery. The subject invention utilizes a blending technique wherein the superposition of one dry transfer decal over another dry transfer decal (or over an appropriately shaded/colored painted surface) provides a virtually imperceptible blending between the various elements. This cumulative effect of these virtually imperceptible blendings of different decorative elements (i.e., paint, dry transfers, dry transfer decals and the like) provide for a versatile method of executing large-scale imagery and/or small scale imagery. Moreover, in difficult surface portions, such as corners, around doors and windows, near floors or ceilings and the like, the blending of many elements to form imagery in a substantially seamless manner allows the use of specific elements that are particularly appropriate to the proximate surface.

In one embodiment of the invention, a kit is provided which includes all of the paint and dry transfer decals necessary to create a desired image. For example, referring to FIG. 3, a kit adapted to providing the flower and fence imagery comprises paint having a color and, optionally, a texture compatible with direct transfer imagery representing the flower and hedge design. It is assumed that the purchaser utilizes a white paint as a base coat. The dry transfer imagery is disposed proximate the boundary between the white base coat and portions of a wall painted with the included compatible paint. In this manner, the representation of large relatively monochrome portions of the image are executed using paint, while detailed portions of the image and those portions proximate the color border region are executed using dry transfer decal. This approach minimizes cost and time to execute the mural.

The subject invention operates to disguise the boundary region wherein a color attributable to paint ends and a color to attributable to a dry transfer begins, thereby creating illusion that a wall is “hand painted.” The paint transfers are designed such that they are visually seamlessly feathered into the body of the wall paint, thereby creating an edge region of a mural.

While foregoing is directed to the preferred embodiment of the present invention, other and further embodiments of the invention may be devised without departing from the basic scope thereof, and the scope thereof is determined by the claims that follow.

1. A method, comprising:
establishing a visual boundary between at least two surface color regions; and
applying a dry transfer object proximate said visual boundary;
said dry transfer object comprising imagery having shading regions adapted to said at least two surface color regions;
said dry transfer object shading regions defining a visual boundary in substantial alignment with said surface color region visual boundary.
